(19) United States
(12) Patent Application Publication
(10) Pub. No.: US 2005/0246066 A1
(43) Pub. Date: Nov. 3, 2005

(54) Method of predicting fertilizer performance

(75) Inventors: Frederick T. Carney JR., Sylacauga, AL (US); Jeffery M. Higgins, Birmingham, AL (US); John H. Detrick, Gulf Breeze, FL (US); Garrard L. Hargrove, Birmingham, AL (US)

Correspondence Address: Breiner & Breiner, L.L.C., P.O. Box 19290, Alexandria, VI, 22320-0290, US

(73) Assignee: Pursell Technologies, Inc., Sylacauga, AL (US)

(21) Appl. No.: 10/834,184

(22) Filed: Apr. 29, 2004

(51) Int. Cl. G05B 21/00

(52) U.S. Cl. 700/266

(57) ABSTRACT

A method of predicting fertilizer performance for optimum efficiency of a fertilizer is described. The method of conducting a computerized fertilizer performance analysis is based upon a request including a plurality of parameter requirements entered on a client computer. A routine is then performed to analyze the plurality of parameter requirements. The routine may be performed by a software program, such as on a provider computer via the Internet, on a CD-ROM inserted into the client computer or downloaded onto the client computer. Upon completion, the fertilizer performance analysis results are received by the client computer and preferably include re-application time, nutrient release indicator, amount of nutrients released, fertilizer nutrient release rate, suggested fertilizer application rate, percent quick release, average nutrient release per time interval, cumulative nutrient release, nutrient longevity, fertilizer spread rate, total amount of fertilizer required or any combination thereof.

### FIELD OF INVENTION

The invention is directed to a method of predicting fertilizer performance. More particularly, the invention is directed to a method of conducting a computerized fertilizer performance analysis based upon a request for a fertilizer performance analysis by a client computer. Specifically, the request includes a plurality of parameter requirements which are entered on the client computer. Once these parameter requirements are entered, a routine is performed to analyze the parameter requirements. The routine may be performed by a software program, such as on a provider computer via the Internet, on a CD-ROM inserted into the client computer or downloaded onto the client computer. Upon completion of the routine, the client computer receives the results of the fertilizer performance analysis.

### BACKGROUND OF THE INVENTION

Many soil environments of the world inherently are nutrient deficient and do not provide optimum growing conditions, especially for perennial plants such as turfgrasses. As such, fertilizers are used to enhance the growth and health of turfgrasses and plants. Fertilizers can enrich a soil environment by providing essential nutrients during periods of high plant nutrient demand, such that turfgrasses and plants will grow more optimally. Turfgrasses and plants growing in a soil environment may require various nutrients in varying amounts and at various times based upon the composition of the soil and the amount of nutrients therein.

In order to achieve and maintain optimum growing conditions in a soil environment, the appropriate amount of nutrients required by turfgrasses in a soil environment may be determined by soil testing and analysis. One or more fertilizers may need to be applied and usually reapplied throughout a growing season or over a specific time period as preferably determined by these tests. For example, to maintain turfgrass soil environments, such as on golf courses, sports facilities or lawns, in prime condition, fertilizers may need to be reapplied to the area at various times and in various amounts from early spring through late fall or occasionally even year-round, depending on turfgrass maintenance practice, the environment and the climate.

For example, in order to keep turfgrass environments, such as golf courses, sports facilities and lawns, in prime condition and to minimize the time and expense associated with fertilizer re-application practices, various controlled release fertilizers have been developed. These controlled release fertilizers are formulated to release fertilizer nutrients following application at a controlled rate when applied to a soil environment such that the turfgrass receives the optimum amount of nutrients over time. One very successful commercial controlled release fertilizer (CRF) is POLYON® polymer coated controlled release fertilizers (PCF), manufactured by Pursell Technologies, Inc. (PTI), located in Sylacauga, Ala. PTI utilizes its REACTIVE LAYERS COATING™ fertilizer technology to produce POLYON® polymer coated urea (PCU) and other PCFs. The production of PCFs is covered by various United States and foreign patents including U.S. Pat. Nos. 4,711,659; 4,804,403; 5,374,292; 5,547,486; 5,858,094, and 6,537,611.

An important issue associated with the application of turfgrass fertilizer, including the application of controlled release fertilizers, is determining the appropriate time or time intervals for applying and re-applying the fertilizer, such that the soil environment consistently maintains a sufficient balance and amount of nutrients for optimum growth, color and density. For turfgrass on golf course fairways and greens, it is particularly significant to obtain a uniform and consistent green color and density of the turfgrass on the course throughout the playing season.

Another important issue associated with turfgrass fertilization practices is choosing an appropriate fertilizer which will provide the optimum balance and quantity of nutrients for the type of soil environment being treated and for the various climates and weather conditions.

Known in the art for providing fertilizer performance analysis for POLYON® PCF is the POLYGRAPH® Fertilizer Performance Predictor (POLYGRAPH® Predictor) computer program. PTI uses the POLYGRAPH® Predictor with golf course superintendents. By inputting program requirements, the POLYGRAPH® Predictor provides a user an analysis of how the POLYON® fertilizer will perform. With the POLYGRAPH® Predictor, a user may also customize a POLYON® fertilizer nutrient analysis for a user's course and climate for a single fertilizer application. The POLYGRAPH® Predictor will provide a user with the amount of nitrogen or potash released each week from the application date. The POLYGRAPH® Predictor will also provide a user with the fertilizer product application rate and the number of 50 pound bags required for the fertilizer application. While the POLYGRAPH® Predictor has been very beneficial in predicting the performance of POLYON® controlled release fertilizer, the POLYGRAPH® Predictor can be improved.

Accordingly, a need exists for an improved method of conducting a fertilizer performance analysis as set forth hereafter. Additionally and particularly, a need exists for an improved method of conducting a fertilizer performance analysis for application of a fertilizer to golf course turfgrasses.

### OBJECTS AND SUMMARY OF THE INVENTION

The present invention is directed to a method of predicting fertilizer performance for optimum efficiency of a fertilizer. More particularly, the present invention is directed to a method of conducting a computerized fertilizer performance analysis based upon a request for a fertilizer performance analysis by a client computer. The request comprises a plurality of parameter requirements that are entered on a client computer. These parameter requirements may be predetermined based upon the desired analysis results. Once these parameter requirements are entered, a routine is performed to analyze the plurality of parameter requirements in the request. The routine may be performed by a software program, such as on a provider computer via the Internet, on a CD-ROM inserted into the client computer or downloaded onto the client computer. Upon completion of the routine, i.e., analysis, the fertilizer performance analysis results are received by the client computer. These results may include an amount of nutrients released from a fertilizer over time; a release rate of the fertilizer nutrients over time to the soil; a suggested application rate of the fertilizer to the soil; a time of re-application of the fertilizer; a percentage of quick release of nutrients to the soil; an average release per time interval of nutrients to the soil; a cumulative release of nutrients to the soil; the nutrient longevity of the fertilizer; a fertilizer spread rate; the total amount of fertilizer needed; an indicator of when the amount of nutrient release falls below the level needed to maintain preferred growing conditions in a fertilizer treated environment, or any combination thereof.

The fertilizer performance analysis results may be displayed on the client computer in table or graphical form. In table form, the fertilizer performance analysis results preferably display the application date of the fertilizer, i.e., starting date of fertilizer treatment, and extends at selected time intervals, such as by weeks, months, days, etc., from the application date. For each time interval, the analysis results display the amount of selected nutrients released during that time interval and the amount of selected nutrients still remaining in the fertilizer to be released. For example, for a weekly time interval, the analysis results may display the amount of nitrogen released during that week and the amount of nitrogen remaining in the fertilizer to be released in weekly intervals. As time progresses and the nutrients from the fertilizer are depleted, the table of analysis results will indicate when the fertilizer nutrient release is no longer effective, i.e., the nutrient release from the applied fertilizer falls below the level needed to maintain that soil environment in a condition which provides optimum growing conditions, thereby maintaining the turfgrass color, density and health in that soil environment. As such, the analysis results will provide a time for fertilizer re-application. These same results may also be displayed in graphical form.

Accordingly, it is a primary object of the present invention to provide an improved method of conducting a computerized fertilizer performance analysis based upon a request by a client computer.

It is a primary object of the present invention to provide an improved method of conducting a computerized performance analysis for a controlled release material having an active ingredient(s) based upon a request by a client computer which will provide an analysis of the release of the active ingredient(s) and provide application and re-application dates for the material.

It is a further primary object of the present invention to provide a method of conducting a computerized fertilizer performance analysis which provides, based upon a plurality of parameter requirements inputted on a client computer, fertilizer performance useful for optimizing the application of the fertilizer including providing an amount of nutrients released from a fertilizer over time; a release rate of the fertilizer nutrients over time to the soil; a suggested application rate of the fertilizer to the soil; a time of re-application of the fertilizer; a percentage of quick release of nutrients to the soil; an average release per time interval of nutrients to the soil; a cumulative release of nutrients to the soil; the nutrient longevity of the fertilizer; a fertilizer spread rate; the total amount of fertilizer needed; an indicator of when the amount of nutrient release falls below the level needed to maintain preferred growing conditions in a fertilizer treated environment, or any combination-thereof.

It is a further primary object of the present invention to provide a method of conducting a computerized fertilizer performance analysis which provides, based upon a plurality of parameter requirements inputted on a client computer, an indicator for when the amount of nutrient release from the fertilizer falls below the level needed to maintain optimum growing conditions in the fertilizer treated environment, i.e. to keep the turfgrass green and healthy.

It is a further primary object of the present invention to provide a method of conducting a computerized fertilizer performance analysis which provides suggested times or dates for re-application of a fertilizer based upon a plurality of parameter requirements inputted on a client computer.

Other objects and advantages of the invention will be apparent from the drawings and the description of the invention herein.

### BRIEF DESCRIPTION OF THE DRAWINGS

Referring to the drawing:

FIG. 1 is a flow chart illustrating an embodiment of steps used to calculate the amount of nutrients released and the amount of nutrients remaining in a fertilizer for each time interval of the fertilizer performance analysis results of the present invention.

FIG. 2 is a flow chart in accordance with FIG. 1 utilizing urea as the single nutrient (nitrogen) fertilizer product.

### DETAILED DESCRIPTION OF THE PREFERRED EMBODIMENTS

The present invention is directed to a method of predicting fertilizer performance. It provides for optimum use of the fertilizer. More particularly, the present invention is directed to a method of conducting a computerized fertilizer performance analysis based upon a request for a fertilizer performance analysis by a client computer. The request preferably includes a plurality of parameter requirements which are inputted, i.e., entered, on a client computer. These parameter requirements may be pre-determined based upon the desired analysis results. Once these parameter requirements are inputted, a routine is performed to analyze the plurality of parameter requirements in the request. The routine may be performed by a software program, such as on a provider computer via the Internet, on a CD-ROM inserted into the client computer or downloaded onto the client computer as conventionally known in the art. Upon completion of the routine, i.e., analysis, one or more fertilizer performance analysis results are received by the client computer.

In a preferred embodiment of the present invention, the method is preferably commenced by a request for a fertilizer performance analysis by a client computer. In order to complete a request, the client computer activates the software program and opens a request screen for the fertilizer performance analysis. In an embodiment of the present invention conducted via the Internet, a user will go to a selected website. The website will preferably include a logon screen where the user will enter a logon name and password before a request screen for the fertilizer performance analysis may be opened.

The request preferably comprises a plurality of parameter requirements which are to be inputted on the client computer. In a preferred embodiment, the plurality of parameter requirements in the request comprises a set of initial parameter requirement fields and a nutrient calculation sheet, which may preferably be a nitrogen calculation sheet or a potash calculation sheet.

The first initial parameter requirement field is preferably a facility type. The facility type is preferably selected from golf course or sports turf. However, any other suitable facility type may be selected. The second initial parameter requirement field is preferably calculation units, which is preferably selected from English or metric system, i.e. International System of Units. The third initial parameter requirement field is preferably turfgrass type, which is preferably selected from warm or cool season type. The next preferred initial parameter requirement field is a geographic location for the facility. This is to tie-in preprogrammed climate conditions (e.g., average weather data as to temperature, precipitation, hours of daylight, or the like) for the geographic location. The parameter requirement field will specifically provide for input of a country where the facility is located. The country requirement field is preferably selected from Canada, Ireland, Mexico, United Kingdom or United States. However, any country may be a possible selection.

In a preferred embodiment, where Canada, Ireland, Mexico or United Kingdom is selected as the country requirement field, then the next preferred initial parameter requirement field is a city requirement field. Specifically, where Canada is selected, the city requirement field is preferably selected from Calgary, Edmonton, Kingston, Montreal, Ottawa, Regina, Toronto, Vancouver or Winnipeg. Where Ireland is selected, the city requirement field is preferably selected from Claremorri, Cork, Dublin or Kilkenny. Where Mexico is selected, the city requirement field is preferably selected from Cabo San Lucas, Cancun, Guadalajara, Mexico City, Monterrey or Puerto Vallarta. Where United Kingdom is selected, the city requirement field is preferably selected from London. While certain cities are provided as possible city selections where Canada, Ireland, Mexico, or the United Kingdom is selected as the country requirement field, any city in that respective country may be a possible selection option for the city requirement field.

In a preferred embodiment, where United States is selected as the country requirement field, the next initial parameter requirement field is preferably a state requirement field. The state requirement field is selected from any state in the United States or the District of Columbia. Once a state is selected, a city requirement field may preferably be selected from various listed cities in that respective state. While only certain cities are provided as possible city selections for each state, any city in that respective state may be a possible selection option for the city requirement field.

Once the city requirement field is selected and any other possible initial parameter requirement fields are inputted, an “Enter” field may be selected which will store the data inputted in the initial parameter requirement fields and lead to an appropriate nutrient calculation sheet based upon the information inputted in the initial parameter requirement fields. In a preferred embodiment, the nutrient calculation sheet is a nitrogen calculation sheet or a potash calculation sheet.

The nutrient calculation sheet, more preferably nitrogen calculation sheet or potash calculation sheet, preferably has various parameter requirement fields to be completed by the client computer. The first set of parameter requirement fields to be inputted on the nutrient calculation sheet, more preferably nitrogen calculation sheet or potash calculation sheet, is preferably a set of general information fields including at least one of: a name of a facility or golf course; a name of a grounds keeper of the facility or superintendent of the golf course; an address for the facility/golf course, preferably including street address, city, state and zip code; a telephone number for the facility/golf course, and a facsimile number for the facility/golf course. However, any suitable general information fields may be required to be inputted on the client computer.

A location field may also be required to be inputted on the nutrient calculation sheet. Alternatively, the location field may automatically be inputted based upon the information previously inputted in the initial parameter requirement fields of the request or optionally may not be required. The next set of parameter requirement fields to be inputted on the nutrient calculation sheet, more preferably nitrogen calculation sheet or potash calculation sheet, is preferably the fertilizer requirement fields which may preferably comprise the following fields or any combination thereof, but are not limited to, (1) acres or area to treat, (2) fertilizer grade analysis percent of nitrogen, phosphate and potash, (3) fertilizer particle size, (4) specified brand fertilizer nutrient grade, e.g., POLYON® fertilizer nutrient grade, (5) percent specified brand fertilizer nutrient grade, e.g., percent POLYON® fertilizer nutrient grade, (6) product list, (7) application date, (8) nutrient application rate and (9) temperature correction. For the purpose of this specification, the controlled release fertilizer referred to will be the PTI POLYON® CRF. However, it is understood that other controlled release fertilizer brands may be utilized in accordance with the present invention.

The number of acres or area of the location which is to be treated with fertilizer may be inputted into the parameter requirement field for acres or area to treat. The parameter requirement field for fertilizer grade analysis percent preferably comprises a percent of nitrogen (N) requirement field, a percent of phosphate (P₂O₅) requirement field, a percent of potash (K₂O) requirement field and any other suitable nutrient. Any suitable percent of nitrogen, phosphate and potash may be inputted in each respective field. The parameter requirement field for fertilizer particle size preferably includes various suitable sizes of fertilizer particles, such as regular, mini or micro particle size as used for POLYON® fertilizer grades. The requirement field for POLYON® fertilizer nutrient grade on a nitrogen calculation sheet is preferably selected from 44, 43, 42, 41, 40, 38.5, 37, 13 or 12. These numbers represent the percent nitrogen available in the POLYON® PCF products. The parameter requirement field for a fertilizer nutrient grade on a potash calculation sheet is preferably selected from 59, 56, 50, 45, 43 or 42. These numbers represent the percent potash available in the polymer coated fertilizer products. A second parameter requirement field for a fertilizer nutrient grade may be utilized for blended fertilizer products containing POLYON® PCFs and other fertilizer material ingredients.

The parameter requirement field for percent POLYON® fertilizer nutrient grade is preferably selected from any suitable percent. A second parameter requirement field for percent POLYON® fertilizer nutrient grade may be utilized for blended fertilizer products containing POLYON® PCFs and other fertilizer material ingredients.

The POLYON® controlled release fertilizer comprises a highly durable ultra-thin polyurethane coating on the fertilizer granule that provides nutrient release at the time predicted for the POLYON® PCF selected to meet the turfgrass needs for major, minor and secondary elements, without the risks of premature or excessive nutrient release associated with conventional fertilizers. Through the patented REACTIVE LAYERS COATING™ fertilizer technology, the ultra-thin POLYON® fertilizer coating is bonded to nutrient granules, creating an extremely durable and reliable granule for close to or one hundred percent controlled release. As a result, turfgrass and horticultural growers can produce higher nutritional quality turfgrass and plants without having to worry about, among other things, the risk of phototoxicity, e.g., fertilizer burn, from premature or excessive nutrient release and subsequent nutrient loss due to coating failures. While POLYON® fertilizer grade and percent POLYON® fertilizer are preferred parameter requirement fields, other brand fertilizers may be used in accordance with the method of the present invention.

The parameter requirement field for product list may be selected from any suitable available fertilizer product. The requirement field for application date may be selected from any calendar date that a user may desire to initially apply the fertilizer to a soil. The parameter requirement field for application rate may be selected from any suitable application rate. The application rate is preferably inputted in pounds nutrient per 1000 square feet (lbs./1000 ft²) or kilograms nutrient per 100 square meters (kgs./100 m²). The parameter requirement field for temperature correction may be selected from any suitable temperature correction unit. The parameter requirement field for temperature correction allows a user to account for differences in the actual temperature compared to average temperatures (recent 30 year average) for a certain location at a certain time of year. Notwithstanding the above parameter requirement fields, any suitable parameter requirement field may be a possible selection on the nutrient calculation sheet, more preferably nitrogen calculation sheet or potash calculation sheet.

Once all of the necessary parameter requirement fields are inputted, a “Calculate” field may be selected on the client computer; If any of the necessary parameter requirement fields are incomplete, the client computer will receive a prompt indicating the parameter requirement field(s) that still need to be inputted before the request may be completed. When the “Calculate” field is selected and all of the parameter requirement fields are complete, the request is completed.

Upon completion of the request, a routine is performed to analyze the plurality of parameter requirement fields inputted on the client computer. The routine may be performed by a software program, such as on a provider computer via the Internet, on a CD-ROM inserted into the client computer or downloaded onto the client computer in any suitable manner known in the art. The routine performed comprises reviewing the information inputted in the parameter requirement fields of the request, comparing this information to actual nutrient release data previously assembled and the results derived therefrom which are stored, such as in databases, calculating the nutrient release for each time interval and accumulating the nutrient release for each time interval. Upon completion of the routine, one or more fertilizer performance analysis results are received by the client computer.

The nutrient release over time from the fertilizer products utilized in the method of the present invention is based upon the diffusion coefficient (DC) of the fertilizer product. In the preferred embodiment of the present invention, the diffusion coefficient (DC) of a fertilizer product is expressed as the average weekly nutrient release rate multiplied by the amount of coating on the fertilizer product. This nutrient release and diffusion coefficient is supported and explained by Fick's Law of Diffusion.

The actual nutrient release data for each of the fertilizer products available as a selection option in the product list requirement field of the nutrient calculation sheet of the request is the basis for the routine in the method of the present invention. Specifically, nutrient release data is stored, such as in a database, by any suitable means known in the art, for each fertilizer product at predetermined intervals, preferably weekly intervals, at temperatures of 10° C., 20° C. and 30° C. The actual nutrient release data may be obtained, for example, by adding a 20 gram sample of a specific coated fertilizer product to 100 grams of water to form a solution. A nutrient-specific inhibitor may also be added to the solution to prevent any conversion. Multiple solution samples may then be made in the same manner for each fertilizer product which is a selection option in the product list requirement field on the nutrient calculation sheet of the request. The solutions may then be placed in a constant temperature incubator. Preferably, at least one solution sample of each fertilizer product is placed in incubators having constant temperatures of 10° C., 20° C. and 30° C., respectively.

At predetermined time intervals, preferably weekly, a measurement is taken from each sample solution to determine the amount of nutrients released from the coated fertilizer product into the solution. A refractometer is preferably used to determine the amount of dissolved nutrients in each solution at each time interval. However, any suitable method or device may be used to measure the amount of nutrients released in each solution at each time interval.

Once the actual nutrient release data are collected, the cumulative release over time is plotted for each product at each temperature. Where multiple samples of each product are used for each temperature, the results may be averaged and then plotted in order to account for sample to sample variation. The weekly measurements are plotted into a smooth release curve for each of the measured temperatures. The release curves are then divided into a suitable number of parts/line segments based upon a curve fitting program for each product. For example, for polymer coated urea, each release curve is divided into six parts/line segments, preferably as follows: 0-50%, 50%-63.5%, 63.5%-75%, 75%-84%, 84%-93% and 93%-100% release. Dividing the polymer coated urea release curves into six parts/line segments preferably gives the most accurate results. A division of less than six parts/line segments for polymer coated urea release curves may not produce smooth transitions from one region or line segment to the next, while a division of more than six parts/line segments may complicate the formulas without significantly increasing the accuracy of the results.

After determining the suitable number of parts/line segments to use in the calculations for a specified product, the diffusion coefficient is calculated for each temperature and each part/line segment in order to give a smooth curve that matches the actual nutrient release. The diffusion coefficients at other temperatures can be extrapolated and plotted to form a smooth curve. The data may then be placed into diffusion coefficient tables (DC tables) corresponding to the part/line segment division of the release curves. For example, for polymer coated urea, the data may be placed into six DC tables. In a preferred embodiment utilizing POLYON® polymer coated urea as the fertilizer product, DC Table 1 comprises the data from release curve segments having 0-50% release. DC Table 2 comprises the data from release curve segments having 50%-63.5% release. DC Table 3 comprises the data from release curve segments having 63.5%-75% release. DC Table 4 comprises the data from release curve segments having 75-84% release. DC Table 5 comprises the data from release curve segments having 84%-93% release. DC Table 6 comprises the data from release curve segments having 93%-100% release.

The nutrient release data and diffusion coefficient data for each product may then be stored in any suitable medium known in the art, such as in a database in the provider computer or on a CD-ROM. The storage medium, such as the provider computer or CD-ROM, may also have stored weekly temperatures for the cities available as a selection in the city requirement field of the request. For example, weekly temperatures for the possible city selections in Canada, Ireland, Mexico, United Kingdom, and United States are stored in the storage medium, i.e., database in the provider computer and/or CD-ROM.

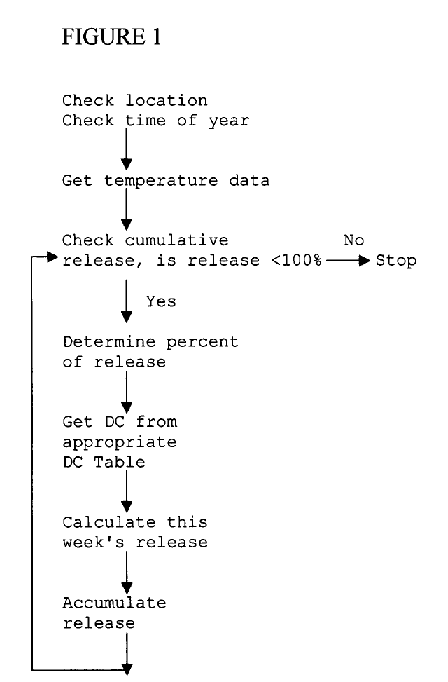

Referring to FIG. 1, in performing a routine upon completion of a request by a client computer, the information inputted in the parameter requirement fields of the request is processed. When processing the fertilizer application date, the city and the country of the fertilizer application, the software program, such as on a provider computer or CD-ROM, refers to the particular stored data to retrieve the expected temperatures for the specified week of the fertilizer application and for each consecutive time interval thereafter of the fertilizer performance analysis results. The stored data for the nutrient release and diffusion coefficient data is then accessed and retrieved from the respective storage medium. The data detailed above may be retrieved in any suitable manner known in the art.

The appropriate diffusion coefficient data are used to determine the cumulative nutrient release for each time interval of the fertilizer performance analysis. Specifically, the cumulative nutrient release at the initial time interval is determined, the diffusion coefficient from the proper DC Table is obtained, the nutrient release for that time interval is calculated and then the total nutrient release is accumulated to arrive at the cumulative nutrient release for that time interval since the application date. This process is repeated for each successive time interval until the cumulative nutrient release of the fertilizer is 100%, whereupon the fertilizer performance analysis is complete and the results are received by the client computer.

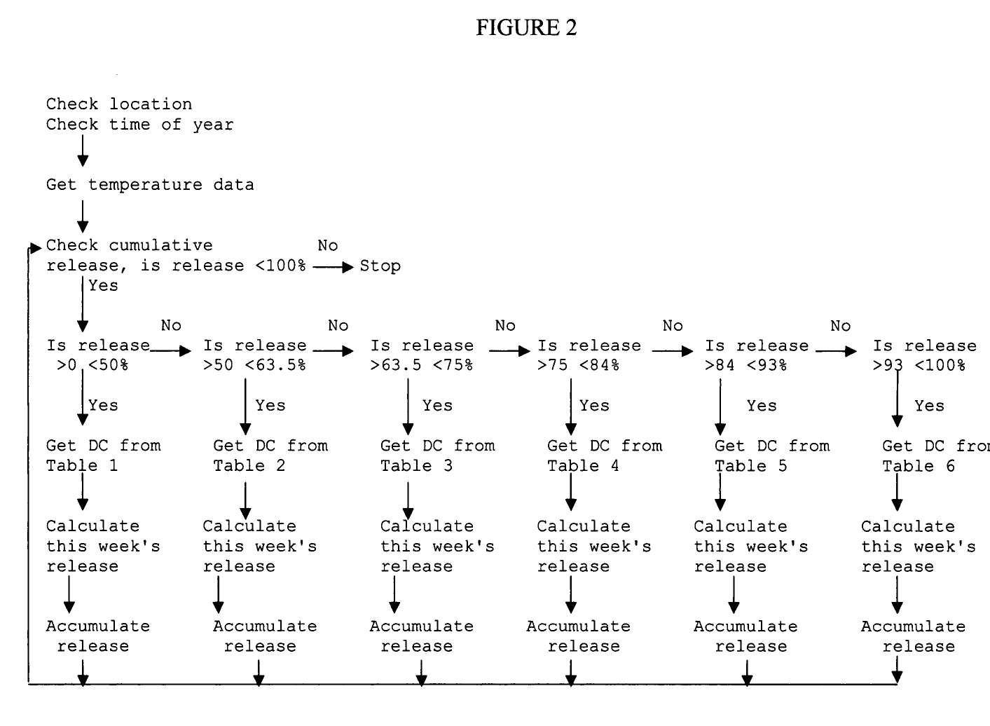

As shown in FIG. 1 and as detailed above, the diffusion coefficient is retrieved from the appropriate DC Table. Referring to FIG. 2, for polymer coated urea, where the cumulative nutrient release is less than 50%, the diffusion coefficient is retrieved from DC Table 1. Where the cumulative nutrient release is between 50%-63.5%, the diffusion coefficient is retrieved from DC Table 2. Where the cumulative nutrient release is between 63.5%-75%, the diffusion coefficient is retrieved from DC Table 3. Where the cumulative nutrient release is between 75%-84%, the diffusion coefficient is retrieved from DC Table 4. Where the cumulative nutrient release is between 84%-93%, the diffusion coefficient is retrieved from DC Table 5. Where the cumulative nutrient release is between 93%-100%, the diffusion coefficient is retrieved from DC Table 6. Once the cumulative nutrient release of the fertilizer is 100%, the routine and fertilizer performance analysis is complete and the fertilizer performance analysis results are received by the client computer that completed the request.

The fertilizer performance analysis results may include an amount of nutrients released over time from a fertilizer; a release rate of the fertilizer nutrients over time to the soil; a suggested application rate of the fertilizer to the soil; a time of re-application of the fertilizer; a percentage of quick release of the nutrients to the soil; an average release per time interval of nutrients to the soil; a cumulative nutrient release, such as at each time interval to the soil; the nutrient longevity of the fertilizer, preferably in weeks; a fertilizer spread rate, preferably in pounds of fertilizer per 1000 square feet (lbs./1000 ft²) or kilograms per 100 square meters (kgs./100 m²); a total amount of fertilizer needed; a total quantity of fertilizer bags needed; an indicator of when the nutrient release falls below the level needed to maintain the preferred conditions in the fertilizer treated environment, or any combination thereof. In a preferred embodiment, the nutrient release rate is preferably displayed in pounds nutrient per 1000 square feet (lbs./1000 ft²), or kilograms nutrient per 100 square meters (kgs./100 m²). The fertilizer nutrients preferably include at least one of nitrogen, phosphate, potash, any other suitable fertilizer nutrients or any combination thereof. The suggested application rate of the fertilizer nutrients to the soil is preferably displayed in pounds nutrient per 1000 square feet (lbs./1000 ft²) or kilograms nutrient per 100 square meters (kgs./100 m²). The timing of re-application is determined by the analysis of the plurality of parameter requirements entered on the request.

The fertilizer performance analysis results may be displayed on the client computer in table or graphical form. In table form, the fertilizer performance analysis results preferably display the starting/application date of the fertilizer treatment and extends by time intervals, preferably by consecutive weeks, from the application date. For each time interval, the table analysis results preferably display the amount of nutrients, such as nitrogen or potash, released during that time interval, and the amount of nutrients, such as nitrogen or potash, remaining in the fertilizer. The amount of nutrients released and the amount of nutrients remaining is preferably displayed in pounds nutrient per 1000 square feet (lbs./1000 ft²) or kilograms nutrient per 100 square meters (kgs./100 m²). As time progresses, the nutrients in the fertilizer are depleted, thereby evidenced by the conclusion of the analysis results in the table.

In the preferred embodiment, the table will indicate when the fertilizer is no longer effective, i.e., the nutrient release falls below the level needed to maintain preferred growing conditions in the soil environment to which the fertilizer has been applied. The indicator may be any suitable indicator or indicating means, such as, but not limited to, an indicator requirement field, a change in color of the table analysis results, such as to red, yellow or light green, or an indicator line inserted in the appropriate position on the table.

In graphic form, the fertilizer performance analysis results preferably display the remaining nutrients in the fertilizer, such as nitrogen or potash, over a specified longevity, preferably by consecutive weeks. In a preferred embodiment, the amount of remaining nutrients in the fertilizer, preferably in pounds nutrient per 1000 square feet (lbs./1000 ft²) or kilograms nutrient per 100 square meters (kgs./100 m²), is plotted along the Y-axis and the longevity, preferably in weeks, is plotted along the X-axis of the graph. The graph will also indicate when the fertilizer is no longer effective, i.e., the nutrient release falls below the level needed to maintain preferred growing conditions in the environment to which the fertilizer has been applied. The indicator may be any suitable indicator or indicating means, such as, but not limited to, an indicator requirement field, a change in color of the plotted graphical analysis results, such as to red, yellow or light green, or an indicator line inserted in the appropriate position on the graph.

Once the client computer receives the fertilizer performance analysis results, a new request may be completed in the same manner as detailed above. In preparing a new request, all of the plurality of parameter requirements may be re-inputted with new information. In the alternative, if the new fertilizer analysis is for the same facility, the set of initial parameter requirement fields may remain unedited, and only the parameter requirement fields of a new nutrient calculation sheet may be inputted. The new information may be inputted into the parameter requirement fields of the previous nutrient calculation sheet or into a new nutrient calculation sheet. If the fertilizer performance analysis results are to be continued from the end of the previous fertilizer performance analysis results or from the time of re-application, a new nutrient calculation sheet may be utilized by selecting a numerical tab in a numerical sequence field on the request. By utilizing a new nutrient calculation sheet, the previous nutrient calculation sheet and fertilizer performance analysis results therefrom are temporarily retained on the client computer and additional fertilizer performance analysis results are added thereto.

The parameter requirement fields of the new nutrient calculation sheet may be inputted as described above; Once completed, the “Calculate” field may be selected, as described above. A routine may then be performed to analyze the plurality of parameter requirements of the new request in the same manner as described above. Upon completion of the routine, the fertilizer analysis results, which are based upon the new information inputted in the plurality of parameter requirements, as described above, are received by the client computer.

In performing further fertilizer performance analyses, a new nutrient calculation sheet may continue to be utilized by selecting the next numerical tab in a numerical sequence field, as described above. This process may be repeated any suitable number of times, wherein each of the previous fertilizer performance analysis results is temporarily retained by the client computer. Previously retained fertilizer analysis results may be combined by selecting a “Combined” field in the numerical sequence field.

If any fertilizer performance analysis results are to be retained for future use or for reference after the analysis or series of analyses are complete, the analysis results may be saved to the client computer in accordance with any conventional manner of saving a file to a computer or may be saved to any other data storage device as known in the art.

The following are examples using the invention. The examples are intended to illustrate the invention and not to limit the invention. The examples illustrate situations where the invention may be used by a golf course superintendent to aid him in developing a fertilizer program for the season. The superintendent may commence the fertilizer performance analysis by going to a selected website and entering his login name and password or by inserting a selected CD-ROM into his computer. The superintendent will enter required information into the plurality of parameter requirements on the request for the fertilizer performance analysis. A routine will then be performed and the superintendent will be provided with the results of the fertilizer performance analysis. The superintendent may vary the parameter requirements in order to try different fertilizer applications. By utilizing the invention, the superintendent can customize the fertilizer program for his golf course to meet his needs, rather than by trial and error. The invention can save the golf course superintendent substantial resources.

### EXAMPLE 1

The superintendent of FARMLINKS™ golf course in Fayetteville, Ala., United States, needs to develop a fertilizer program for the season to keep the fairways in preferred conditions for the summer. He wants to apply a fertilizer during the last week of April and does not want to have to re-apply fertilizer until mid-August. He wishes to determine or confirm the fertilizer blend to use, the fertilizer grade to use, and the application rate of nitrogen to use in order to achieve his objectives.

The superintendent uses the invention to determine or confirm his objectives without the attendant problems of trial and error. The superintendent, using the CD-ROM with the present invention, enters data, i.e., pre-selected information, into the parameter requirements on the request. After entering the data into the parameter requirement fields of the request, a routine is performed. The superintendent then receives the fertilizer analysis results, based upon the parameter requirements entered on the request. The superintendent reviews these results. If the data entered in the request does not provide the superintendent with his preferred results, he modifies the data entered into the parameter requirements until he receives the preferred results. The superintendent then knows the fertilizer blend, fertilizer grade, application rate of nitrogen, re-application time, etc. that he will use for this season's fertilizer program for the golf course. The following is an example of the data entered by the superintendent providing him with a preferred fertilizer program based on his requirements.

In the initial parameter requirement fields, the superintendent enters the following data:
facility type: golf course; calculation units: English; turfgrass type: warm; country: United States; state: Alabama, and city: Fayetteville/FARMLINKS™.

The superintendent then selects the “Enter” field, which leads to a nutrient calculation sheet. Specifically, the superintendent chooses a nitrogen calculation sheet for this analysis. In the nitrogen calculation sheet, the superintendent enters the following preferred data after entering background information, such as name, address, telephone number, etc. for FARMLINKS™ golf course:
number of acres to treat: 10; fertilizer grade analysis percent of nitrogen: 20, phosphate: 5, potash: 10; fertilizer particle size: regular; POLYON® fertilizer nutrient grade: 42, 44; percent POLYON® fertilizer nutrient grade: 100, 0; product: POLYON® PCU; application date: Apr. 27, 2004; nutrient application rate (lbs. nitrogen/1000 ft²): 1.5, and temperature correction: 0.

The superintendent then selects the “Calculate” field and receives the fertilizer performance analysis results. These results preferably include the following:
percentage of quick release of nitrogen to the soil: 0.00; fertilizer spread rate (lbs./1000 ft²): 7.50; total tons of fertilizer needed: 1.63; number of 50 lb. bags of fertilizer needed: 66; average release per week of nitrogen (lbs.) to the soil: 0.07; nutrient longevity of the fertilizer (weeks): 17; and suggested re-application time: Week 17 (Aug. 17, 2004).

The superintendent also receives the amount of nitrogen released from the fertilizer and the amount of nitrogen remaining to be released from the fertilizer for each week of the analysis results, preferably as follows:

| | | Released N | Remaining N |
|---|---|---|---|
| Apr. 27, 2004 | Week 1 | 0.01 | 1.48 |
| May 04, 2004 | Week 2 | 0.06 | 1.42 |
| May 11, 2004 | Week 3 | 0.07 | 1.35 |
| May 18, 2004 | Week 4 | 0.08 | 1.27 |
| May 25, 2004 | Week 5 | 0.08 | 1.19 |
| Jun. 01, 2004 | Week 6 | 0.09 | 1.11 |
| Jun. 08, 2004 | Week 7 | 0.09 | 1.01 |
| Jun. 15, 2004 | Week 8 | 0.10 | 0.92 |
| Jun. 22, 2004 | Week 9 | 0.10 | 0.82 |
| Jun. 29, 2004 | Week 10 | 0.10 | 0.71 |
| Jul. 06, 2004 | Week 11 | 0.09 | 0.62 |
| Jul. 13, 2004 | Week 12 | 0.09 | 0.53 |
| Jul. 20, 2004 | Week 13 | 0.06 | 0.47 |
| Jul. 27, 2004 | Week 14 | 0.06 | 0.40 |
| Aug. 03, 2004 | Week 15 | 0.06 | 0.34 |
| Aug. 10, 2004 | Week 16 | 0.05 | 0.29 |
| Aug. 17, 2004 | Week 17 | 0.05 | 0.25 |
| Aug. 24, 2004 | Week 18 | 0.05 | 0.20 |
| Aug. 31, 2004 | Week 19 | 0.03 | 0.17 |
| Sep. 07, 2004 | Week 20 | 0.03 | 0.14 |
| Sep. 14, 2004 | Week 21 | 0.03 | 0.11 |
| Sep. 21, 2004 | Week 22 | 0.03 | 0.09 |
| Sep. 28, 2004 | Week 23 | 0.02 | 0.07 |
| Oct. 05, 2004 | Week 24 | 0.01 | 0.06 |
| Oct. 12, 2004 | Week 25 | 0.01 | 0.05 |
| Oct. 19, 2004 | Week 26 | 0.01 | 0.04 |
| Oct. 26, 2004 | Week 27 | 0.01 | 0.03 |
| Nov. 02, 2004 | Week 28 | 0.01 | 0.02 |
| Nov. 09, 2004 | Week 29 | 0.01 | 0.01 |
| Nov. 16, 2004 | Week 30 | 0.01 | 0.00 |
| Nov. 23, 2004 | Week 31 | 0.00 | 0.00 |

The fertilizer performance analysis and results provide the superintendent with the fertilizer blend, fertilizer grade, application rate of nitrogen, suggested re-application time, etc. that meets his preferred objectives for this season's fertilizer program. As such, the suggested fertilizer re-application time is during the week of Aug. 17, 2004, which meets the superintendent's re-application objective.

### EXAMPLE 2

FARMLINKS™ golf course in Fayetteville, Ala., United States, is sponsoring a golf tournament in late August and wants the turfgrass on the fairways to be green, healthy and in optimum condition for the tournament. The FARMLINKS™ golf course superintendent does not want to have to re-apply fertilizer shortly before the tournament due to attendant problems. Accordingly, the present invention is used by the golf course superintendent to predict fertilizer performance, specifically re-application time, and is used to determine the appropriate fertilizer requirements to meet his needs. This example illustrates the invention wherein a fertilizer re-application time, the resulting amount of nitrogen released from the fertilizer since the time of re-application and the amount of nitrogen remaining to be released from the fertilizer since the time of re-application are among the fertilizer performance analysis results.

The superintendent uses the invention to achieve his objectives and to avoid any miscalculation or trial and error. The superintendent, using a CD-ROM with the present invention, enters data into the parameter requirements on the request as in Example 1. After inputting the data into the parameter requirement fields of the request, a routine is performed. The superintendent then receives the fertilizer analysis results. If the data entered in the request does not provide the superintendent with the preferred results, he may modify the data inputted and re-run the program until he obtains the preferred fertilizer performance. The superintendent, using the invention, may determine the preferred fertilizer blend, fertilizer nutrient grade, application rate of nitrogen, re-application time, etc. that he will use for this season's fertilizer program for the golf course, and particularly, to ensure that the golf course is in pristine condition for the tournament.

For determining the fertilizer application and re-application to provide optimum green fairways, the superintendent ultimately uses the following. In the initial parameter requirement fields, he enters the following data:
facility type: golf course; calculation units: English; turfgrass type: warm; country: United States; state: Alabama, and city: Fayetteville/FARMLINKS™.

He then selects the “Enter” field, which leads to a nutrient calculation sheet. The superintendent selects the nitrogen calculation sheet for this analysis. In the nitrogen calculation sheet, he enters the following data (after entering background information, such as name, address, telephone number, etc. for FARMLINKS™ golf course):
number of acres to treat: 10; fertilizer grade analysis percent of nitrogen: 41, phosphate: 0, potash: 0; fertilizer particle size: mini; POLYON® fertilizer nutrient grade: 41, 41; percent POLYON® fertilizer nutrient grade: 100, 0; product: POLYON® 41 mini; application date: Mar. 2, 2004; nutrient application rate (lbs. nitrogen/1000 ft²): 2.0, and temperature correction: 0.

The superintendent then selects the “Calculate” field and receives the fertilizer performance analysis results. These results include, but are not limited to, the following:
percentage of quick release of nitrogen to the soil: 0.00; fertilizer spread rate (lbs./1000 ft²): 4.88; total tons of fertilizer needed: 1.06; number of 50 lb. bags of fertilizer needed: 42.44; average release per week of nitrogen (lbs.): 0.08; nutrient longevity of the fertilizer (weeks): 22; suggested re-application time: Week 22 (Jul. 27, 2004).

The superintendent also receives the amount of nitrogen released from the fertilizer and the amount of nitrogen remaining to be released from the fertilizer for each week, preferably as follows:

| | | Released N | Remaining N |
|---|---|---|---|
| Mar. 02, 2004 | Week 1 | 0.00 | 2.00 |
| Mar. 09, 2004 | Week 2 | 0.04 | 1.96 |
| Mar. 16, 2004 | Week 3 | 0.05 | 1.91 |
| Mar. 23, 2004 | Week 4 | 0.05 | 1.86 |
| Mar. 30, 2004 | Week 5 | 0.06 | 1.80 |
| Apr. 06, 2004 | Week 6 | 0.06 | 1.74 |
| Apr. 13, 2004 | Week 7 | 0.07 | 1.67 |
| Apr. 20, 2004 | Week 8 | 0.07 | 1.60 |
| Apr. 27, 2004 | Week 9 | 0.08 | 1.52 |
| May 04, 2004 | Week 10 | 0.09 | 1.43 |
| May 11, 2004 | Week 11 | 0.09 | 1.34 |
| May 18, 2004 | Week 12 | 0.10 | 1.24 |
| May 25, 2004 | Week 13 | 0.10 | 1.14 |
| Jun. 01, 2004 | Week 14 | 0.12 | 1.02 |
| Jun. 08, 2004 | Week 15 | 0.12 | 0.90 |
| Jun. 15, 2004 | Week 16 | 0.12 | 0.78 |
| Jun. 22, 2004 | Week 17 | 0.12 | 0.66 |
| Jun. 29, 2004 | Week 18 | 0.08 | 0.58 |
| Jul. 06, 2004 | Week 19 | 0.08 | 0.50 |
| Jul. 13, 2004 | Week 20 | 0.07 | 0.43 |
| Jul. 20, 2004 | Week 21 | 0.07 | 0.36 |
| Jul. 27, 2004 | Week 22 | 0.07 | 0.29 |
| Aug. 03, 2004 | Week 23 | 0.05 | 0.24 |
| Aug. 10, 2004 | Week 24 | 0.05 | 0.19 |
| Aug. 17, 2004 | Week 25 | 0.04 | 0.15 |
| Aug. 24, 2004 | Week 26 | 0.03 | 0.12 |
| Aug. 31, 2004 | Week 27 | 0.03 | 0.09 |
| Sep. 07, 2004 | Week 28 | 0.03 | 0.06 |
| Sep. 14, 2004 | Week 29 | 0.02 | 0.04 |
| Sep. 21, 2004 | Week 30 | 0.02 | 0.02 |
| Sep. 28, 2004 | Week 31 | 0.02 | 0.00 |

These results provide the preferred application and re-application dates, i.e. the re-application time of Week 22 (Jul. 27, 2004), which is before the golf tournament and within his acceptable time for fertilizer re-application. The superintendent then wishes to enter a second calculation for the course. He uses the combination of calculations mode of the invention which allows him to utilize a new nitrogen calculation sheet. On this new nitrogen calculation sheet, the suggested re-application time, Jul. 27, 2004, is entered by the program in the application date parameter requirement field and then the user also enters the following data:
number of acres to treat: 10; fertilizer grade analysis percent of nitrogen: 43, phosphate: 0, potash: 0; fertilizer particle size: mini; POLYON® fertilizer nutrient grade: 43, 43; percent POLYON® fertilizer nutrient grade: 100, 0; product: POLYON® 43 mini; nutrient application rate (lbs. nitrogen/1000 ft²): 1.0 and temperature correction: 0.

The superintendent selects the “Calculate” field and receives the fertilizer performance analysis results. The superintendent then selects the “Combine” field and receives the combined results from the first fertilizer performance analysis and the second fertilizer performance analysis. The amount of nitrogen released from the fertilizers and the amount of nitrogen remaining to be released from the fertilizers are as follows:

| | | Released N | Remaining N |
|---|---|---|---|
| Mar. 02, 2004 | Week 1 | 0.00 | 2.00 |
| Mar. 09, 2004 | Week 2 | 0.04 | 1.96 |
| Mar. 16, 2004 | Week 3 | 0.05 | 1.91 |
| Mar. 23, 2004 | Week 4 | 0.05 | 1.86 |
| Mar. 30, 2004 | Week 5 | 0.06 | 1.80 |
| Apr. 06, 2004 | Week 6 | 0.06 | 1.74 |
| Apr. 13, 2004 | Week 7 | 0.07 | 1.67 |
| Apr. 20, 2004 | Week 8 | 0.07 | 1.60 |
| Apr. 27, 2004 | Week 9 | 0.08 | 1.52 |
| May 04, 2004 | Week 10 | 0.09 | 1.43 |
| May 11, 2004 | Week 11 | 0.09 | 1.34 |
| May 18, 2004 | Week 12 | 0.10 | 1.24 |
| May 25, 2004 | Week 13 | 0.10 | 1.14 |
| Jun. 01, 2004 | Week 14 | 0.12 | 1.02 |
| Jun. 08, 2004 | Week 15 | 0.12 | 0.90 |
| Jun. 15, 2004 | Week 16 | 0.12 | 0.78 |
| Jun. 22, 2004 | Week 17 | 0.12 | 0.66 |
| Jun. 29, 2004 | Week 18 | 0.08 | 0.58 |
| Jul. 06, 2004 | Week 19 | 0.08 | 0.50 |
| Jul. 13, 2004 | Week 20 | 0.07 | 0.43 |
| Jul. 20, 2004 | Week 21 | 0.07 | 0.36 |
| Jul. 27, 2004 | Week 22 | 0.10 | 1.26 |
| Aug. 03, 2004 | Week 23 | 0.18 | 1.08 |
| Aug. 10, 2004 | Week 24 | 0.17 | 0.91 |
| Aug. 17, 2004 | Week 25 | 0.16 | 0.75 |
| Aug. 24, 2004 | Week 26 | 0.15 | 0.60 |
| Aug. 31, 2004 | Week 27 | 0.13 | 0.47 |
| Sep. 07, 2004 | Week 28 | 0.12 | 0.35 |
| Sep. 14, 2004 | Week 29 | 0.08 | 0.27 |
| Sep. 21, 2004 | Week 30 | 0.07 | 0.20 |
| Sep. 28, 2004 | Week 31 | 0.04 | 0.16 |
| Oct. 05, 2004 | Week 32 | 0.02 | 0.14 |
| Oct. 12, 2004 | Week 33 | 0.02 | 0.12 |
| Oct. 19, 2004 | Week 34 | 0.02 | 0.10 |
| Oct. 26, 2004 | Week 35 | 0.02 | 0.08 |
| Nov. 02, 2004 | Week 36 | 0.01 | 0.07 |
| Nov. 09, 2004 | Week 37 | 0.01 | 0.06 |
| Nov. 16, 2004 | Week 38 | 0.01 | 0.05 |
| Nov. 23, 2004 | Week 39 | 0.01 | 0.04 |
| Nov. 30, 2004 | Week 40 | 0.01 | 0.03 |

These results meet the superintendent's preferred fertilizer performance objectives. As shown, at Week 22 (Jul. 27, 2004), a few weeks before the golf tournament, fertilizer, as detailed above, should be re-applied so that the golf course fairways are in preferred condition for the FARMLINKS™ golf tournament in late August.

### EXAMPLE 3

Fertilizers may perform differently in various climates. As such, the controlled release fertilizer grade may play a significant role in the selection of the fertilizer. For example, a fertilizer may not provide the same results for cool season turfgrass as for warm season turfgrass. Therefore, the present invention is beneficial for determining fertilizer performance for warm and cool season turfgrasses. This example illustrates fertilizer performance analysis results for cool season turfgrass type utilizing the present invention.

The superintendent of a golf course in Pittsburgh, Pa. uses the invention, generally as described in the examples above, to determine, among other things, fertilizer performance and fertilizer re-application time, as described below. In the initial parameter requirement fields of the request, she enters the following data:
facility type: golf course; calculation units: English; turfgrass type: cool; country: United States; state: Pennsylvania, and city: Pittsburgh. She then selects the “Enter” field, which leads to a nutrient calculation sheet, preferably a nitrogen calculation sheet. In the nitrogen calculation sheet, the superintendent enters the following preferred data after entering general information, such as name, address, telephone number, etc. for his golf course:
number of acres to treat: 10; fertilizer grade analysis percent of nitrogen: 20, phosphate: 5, potash: 10; fertilizer particle size: regular; POLYON® fertilizer nutrient grade: 43, 44; percent POLYON® fertilizer nutrient grade: 100, 0; product: POLYON® PCU; application date: Apr. 9, 2004; nutrient application rate (lbs. nitrogen/1000 ft²): 1.5, and temperature correction: 0. She then selects the “Calculate” field and receives the fertilizer performance analysis results. These results include the following:

percentage of quick release of nitrogen to the soil: 0.00; fertilizer spread rate (lbs./1000 ft²): 7.50; total tons of fertilizer needed: 1.63; number of 50 lb. bags of fertilizer needed: 65.25; average release per week of nitrogen (lbs.): 0.07; nutrient longevity of the fertilizer (weeks): 17, and suggested re-application time: Week 17 (Jul. 30, 2004). The amount of nitrogen released and remaining to be released from the fertilizer is as follows:

| | | Released N | Remaining N |
|---|---|---|---|
| Apr. 09, 2004 | Week 1 | 0.00 | 1.50 |
| Apr. 16, 2004 | Week 2 | 0.04 | 1.46 |
| Apr. 23, 2004 | Week 3 | 0.05 | 1.41 |
| Apr. 30, 2004 | Week 4 | 0.05 | 1.36 |
| May 07, 2004 | Week 5 | 0.07 | 1.29 |
| May 14, 2004 | Week 6 | 0.07 | 1.22 |
| May 21, 2004 | Week 7 | 0.08 | 1.14 |
| May 28, 2004 | Week 8 | 0.09 | 1.06 |
| Jun. 04, 2004 | Week 9 | 0.09 | 0.96 |
| Jun. 11, 2004 | Week 10 | 0.10 | 0.86 |
| Jun. 18, 2004 | Week 11 | 0.10 | 0.76 |
| Jun. 25, 2004 | Week 12 | 0.11 | 0.65 |
| Jul. 02, 2004 | Week 13 | 0.10 | 0.56 |
| Jul. 09, 2004 | Week 14 | 0.10 | 0.46 |
| Jul. 16, 2004 | Week 15 | 0.07 | 0.39 |
| Jul. 23, 2004 | Week 16 | 0.07 | 0.33 |
| Jul. 30, 2004 | Week 17 | 0.05 | 0.28 |
| Aug. 06, 2004 | Week 18 | 0.05 | 0.22 |
| Aug. 13, 2004 | Week 19 | 0.03 | 0.19 |
| Aug. 20, 2004 | Week 20 | 0.03 | 0.16 |
| Aug. 27, 2004 | Week 21 | 0.03 | 0.13 |
| Sep. 03, 2004 | Week 22 | 0.03 | 0.10 |
| Sep. 10, 2004 | Week 23 | 0.02 | 0.08 |
| Sep. 17, 2004 | Week 24 | 0.02 | 0.07 |
| Sep. 24, 2004 | Week 25 | 0.01 | 0.05 |
| Oct. 01, 2004 | Week 26 | 0.01 | 0.04 |
| Oct. 08, 2004 | Week 27 | 0.01 | 0.03 |
| Oct. 15, 2004 | Week 28 | 0.01 | 0.02 |
| Oct. 22, 2004 | Week 29 | 0.01 | 0.01 |
| Oct. 29, 2004 | Week 30 | 0.01 | 0.01 |
| Nov. 05, 2004 | Week 31 | 0.00 | 0.00 |
| Nov. 12, 2004 | Week 32 | 0.00 | 0.00 |
| Nov. 19, 2004 | Week 33 | 0.00 | 0.00 |

The fertilizer performance analysis and results provides the superintendent with the fertilizer nutrient grade, application rate of nitrogen, suggested re-application time, etc. that meets her preferred objectives for this season's fertilizer program. As such, the suggested re-application time for the superintendent to re-apply fertilizer is during the week of Jul. 30, 2004.

While the preferred parameter requirement fields have been described above, other suitable parameter requirements not described may be included and inputted in order to obtain the fertilizer performance analysis results in accordance with the present invention. As such, soil fertility data and information may be inputted in order to determine what nutrients the soil needs and provide a recommended/suggested fertilizer and application rate. For example, where potash is the desired nutrient, a soil sample would be analyzed to provide a soil analysis. This data would then be inputted into the appropriate parameter requirement fields. The method of the present invention would then provide the fertilizer analysis results detailed above.

While the method of the present invention has been described in terms of controlled release fertilizers as the preferred product, any suitable controlled release products, such as, but not limited to, pesticides, e.g. insecticides, fungicides and/or herbicides, may be utilized in accordance with the method of the present invention and fall within the scope of the description above. Revision of parameter requirements or analysis results relating to the controlled release product and corresponding actives are apparent and also fall within the scope of the description above. Additionally, the method of the present invention may be used for applications other than turfgrass, such as, but not limited to, plant nursery applications and other suitable agricultural applications.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A method of performing a computerized fertilizer performance analysis comprising:
(a) inputting a plurality of parameter requirements in a request on a client computer;
(b) analyzing said plurality of parameter requirements in said request, wherein a routine is used to analyze said plurality of parameter requirements;
(c) calculating at least one fertilizer performance analysis result based upon said analyzing of said plurality of parameter requirements from said request; and
(d) receiving said at least one fertilizer performance analysis result by said client computer, wherein said at least one fertilizer performance analysis result comprises a time of re-application of a fertilizer and optionally at least one of an amount of nutrients released at a plurality of pre-selected time intervals from a fertilizer; a release rate of fertilizer nutrients over time to a soil, or a suggested application rate of a fertilizer to a soil.

2. The method of claim 1, wherein said routine comprises:
reviewing said plurality of parameter requirements inputted in said request;
comparing said plurality of parameter requirements inputted in said request to actual nutrient release data stored in a storage medium; and
calculating and accumulating nutrient release for a series of time intervals based upon said plurality of parameter requirements inputted in said request.

3. The method according to claim 1, wherein said at least one fertilizer performance analysis result provides said release rate in pounds nutrient per 1000 square feet or kilograms nutrient per 100 square meters.

4. The method according to claim 1, wherein said at least one fertilizer performance analysis result provides said suggested application rate of said fertilizer in pounds per 1000 square feet or kilograms per 100 square meters.

5. The method according to claim 1, wherein said fertilizer nutrients include at least one of nitrogen, phosphate, potash or any combination thereof.

6. The method according to claim 1, wherein said time of re-application is determined by said plurality of parameter requirements inputted in said request and an amount of nutrients depleted from said fertilizer.

7. The method according to claim 1, wherein said plurality of parameter requirements include at least one of facility type, calculation units, turfgrass type, country, state, city, name of facility/golf course, name of groundskeeper/superintendent, address and telephone number of facility/golf course, acres or area to treat, fertilizer grade analysis percent, fertilizer particle size, fertilizer nutrient grade, percent fertilizer nutrient grade, product list, application date, application rate, temperature correction or any combination thereof.

8. The method according to claim 7, wherein said facility type includes at least one of golf course or sports turf.

9. The method according to claim 7, wherein said calculation units include at least one of English or metric units.

10. The method according to claim 7, wherein said turfgrass type includes at least one of warm or cool season type.

11. The method according to claim 7, wherein said country includes at least one of Canada, Ireland, Mexico, United Kingdom or United States.

12. The method according to claim 7, wherein said fertilizer grade analysis percent includes at least one of a percent of nitrogen, percent of phosphate (P₂O₅), percent of potash (K₂O) or any combination thereof.

13. The method according to claim 7, wherein said fertilizer particle size includes at least one of regular, mini or micro particle size.

14. The method according to claim 7, wherein said fertilizer nutrient grade includes at least one of 44, 43, 42, 41, 40, 38.5, 37, 13 or 12 percent nitrogen available in a fertilizer.

15. The method according to claim 7, wherein said fertilizer nutrient grade includes at least one of 59, 56, 50, 45, 43, or 42 percent potash available in a fertilizer.

16. The method according to claim 1, wherein said at least one fertilizer performance analysis result further comprises a percent quick release, average nutrient release per time interval, cumulative release of nutrients, nutrient longevity, fertilizer spread rate, total amount of fertilizer required or any combination thereof.

17. The method according to claim 1, wherein said at least one fertilizer performance analysis result further comprises an indicator of when nutrient release falls below a level required to maintain optimum growing conditions in a fertilizer treated environment.

18. The method according to claim 16, said method further comprising:
repeating (a) through (d) to receive a new at least one fertilizer performance analysis result based upon a new plurality of parameter requirements inputted in a request on said client computer.

19. The method according to claim 1, said method further comprising:
repeating (a) through (d) to receive a new at least one fertilizer performance analysis result based upon a new plurality of parameter requirements inputted in a request on said client computer.

20. A method of performing a computerized on-line fertilizer performance analysis comprising:
(a) inputting a plurality of parameter requirements in a request on a client computer;
(b) sending said request from said client computer to a provider computer;
(c) receiving said request by said provider computer for a fertilizer performance analysis;
(d) analyzing said plurality of parameter requirements in said request, wherein said provider computer uses a routine to analyze said plurality of parameter requirements;
(e) calculating at least one fertilizer performance analysis result based upon said analyzing of said plurality of parameter requirements from said request; and
(f) receiving said at least one fertilizer performance analysis result by said client computer, wherein said at least one fertilizer performance analysis result comprises a time of re-application of a fertilizer and optionally at least one of an amount of nutrients released at a plurality of pre-selected time intervals from a fertilizer; a release rate of fertilizer nutrients over time to a soil, or a suggested application rate of a fertilizer to a soil.

21. The method of claim 20, wherein said routine comprises:
reviewing said plurality of parameter requirements inputted in said request;
comparing said plurality of parameter requirements inputted in said request to actual nutrient release data stored in a storage medium; and
calculating and accumulating nutrient release for a series of time intervals based upon said plurality of parameter requirements inputted in said request.

22. The method according to claim 20, wherein said at least one fertilizer performance analysis result provides said release rate in pounds nutrient per 1000 square-feet or kilograms nutrient per 100 square meters.

23. The method according to claim 20, wherein said at least one fertilizer performance analysis result provides said suggested application rate of said fertilizer in pounds per 1000 square feet or kilograms per 100 square meters.

24. The method according to claim 20, wherein said fertilizer nutrients include at least one of nitrogen, phosphate, potash or any combination thereof.

25. The method according to claim 20, wherein said time of re-application is determined by said plurality of parameter requirements inputted in said request and an amount of nutrients depleted from said fertilizer.

26. The method according to claim 20, wherein said plurality of parameter requirements include at least one of facility type, calculation units, turfgrass type, country, state, city, name of facility/golf course, name of groundskeeper/superintendent, address and telephone number of facility/golf course, acres or area to treat, fertilizer grade analysis percent, fertilizer particle size, fertilizer nutrient grade, percent fertilizer nutrient grade, product list, application date, nutrient application rate, temperature correction or any combination thereof.

27. The method according to claim 26, wherein said facility type includes at least one of golf course or sports turf.

28. The method according to claim 26, wherein said calculation units include at least one of English or metric units.

29. The method according to claim 26, wherein said turfgrass type includes at least one of warm or cool.

30. The method according to claim 26, wherein said country includes at least one of Canada, Ireland, Mexico, United Kingdom or United States.

31. The method according to claim 26, wherein said fertilizer grade analysis percent includes at least one of a percent of nitrogen, percent of phosphate (P₂O₅), percent of potash (K₂O) or any combination thereof.

32. The method according to claim 26, wherein said fertilizer particle size includes at least one of regular, mini or micro particle size.

33. The method according to claim 26, wherein said fertilizer nutrient grade includes at least one of 44, 43, 42, 41, 40, 38.5, 37, 13 or 12 percent nitrogen available in a fertilizer.

34. The method according to claim 26, wherein said fertilizer nutrient grade includes at least one of 59, 56, 50, 45, 43, or 42 percent potash available in a fertilizer.

35. The method according to claim 20, wherein said at least one fertilizer performance analysis result further comprises a percent quick release, average nutrient release per time interval, cumulative release of nutrients, nutrient longevity, fertilizer spread rate, total amount of fertilizer required or any combination thereof.

36. The method according to claim 20, wherein said at least one fertilizer performance analysis result further comprises an indicator of when nutrient release falls below a level required to maintain optimum growing conditions in a fertilizer treated environment.

37. The method according to claim 35, said method further comprising:
repeating (a) through (f) to receive a new at least one fertilizer performance analysis result based upon a new plurality of parameter requirements inputted in a request on said client computer.

38. The method according to claim 20, said method further comprising:
repeating (a) through (f) to receive a new at least one fertilizer performance analysis result based upon a new plurality of parameter requirements inputted in a request on said client computer.

39. A method of performing a computerized performance analysis for a pesticidal controlled release product comprising:
(a) inputting a plurality of parameter requirements in a request on a client computer;
(b) analyzing said plurality of parameter requirements in said request, wherein a routine is used to analyze said plurality of parameter requirements;
(c) calculating at least one controlled release product performance analysis result based upon said analyzing of said plurality of parameter requirements from said request; and
(d) receiving said at least one controlled release product performance analysis result by said client computer, wherein said at least one controlled release product performance analysis result comprises a time of re-application of a controlled release product and optionally at least one of an amount of at least one pesticidal active released at a plurality of pre-selected time intervals from a controlled release product; a release rate of at least one pesticidal active from said controlled release product over time to a soil; a suggested application rate of a controlled release product to a soil, or a controlled release product analysis of at least one pesticidal active.

40. A method of performing a computerized on-line pesticidal controlled release product performance analysis comprising:
(a) inputting a plurality of parameter requirements in a request on a client computer;
(b) sending said request from said client computer to a provider computer;
(c) receiving said request by said provider computer for a controlled release product performance analysis;
(d) analyzing said plurality of parameter requirements in said request, wherein said provider computer uses a routine to analyze said plurality of parameter requirements;
(e) calculating at least one controlled release product performance analysis result based upon said analyzing of said plurality of parameter requirements from said request; and
(f) receiving said at least one controlled release product performance analysis result by said client computer, wherein said at least one controlled release product performance analysis result comprises a time of re-application of a controlled release product and optionally at least one of an amount of at least one pesticidal active released at a plurality of pre-selected time intervals from a controlled release product; a release rate of at least one pesticidal active from said control led release product over time to a soil; a suggested application rate of a controlled release product to a soil, or a controlled release product analysis of at least one pesticidal active.

41. The method of claim 39 or 40, wherein said routine comprises:
reviewing said plurality of parameter requirements inputted in said request;
comparing said plurality of parameter requirements inputted in said request to actual pesticidal active or actives release data stored in a storage medium; and
calculating and accumulating pesticidal active or actives release for a series of time intervals based upon said plurality of parameter requirements inputted in said request.

42. The method according to claim 39 or 40, wherein said at least one controlled release product performance analysis result provides said release rate in pounds active or actives per 1000 square feet or kilograms active or actives per 100 square meters.

43. The method according to claim 39 or 40, wherein said at least one controlled release product performance analysis result provides said suggested application rate of said controlled release product in pounds per 1000 square feet or kilograms per 100 square meters.

44. The method according to claim 39 or 40, wherein said plurality of parameter requirements include at least one of facility type, calculation units, country, state, city, name of facility, name of groundskeeper, address and telephone number of facility, acres or area to treat, controlled release product analysis percent, particle size, percent active or actives, product list, application date, application rate, temperature correction or any combination thereof.

45. The method according to claim 44, wherein said calculation units include at least one of English or metric units.

46. The method according to claim 39 or 40, wherein said at least one controlled release product performance analysis result further comprises an indicator of when active or actives release falls below a level required to maintain optimum pest control in a controlled release product treated environment.

47. The method according to claim 39, said method further comprising:
repeating (a) through (d) to receive a new at least one controlled release product performance analysis result based upon a new plurality of parameter requirements inputted in a request on said client computer.

48. The method according to claim 40, said method further comprising:
repeating (a) through (f) to receive a new at least one controlled release product performance analysis result based upon a new plurality of parameter requirements inputted in a request on said client computer.

49. A method of performing a computerized performance analysis for a controlled release product including at least one active comprising:
(a) inputting a plurality of parameter requirements in a request on a client computer;
(b) analyzing said plurality of parameter requirements in said request, wherein a routine is used to analyze said plurality of parameter requirements;
(c) calculating at least one controlled release product performance analysis result based upon said analyzing of said plurality of parameter requirements from said request; and
(d) receiving said at least one controlled release product performance analysis result by said client computer, wherein said at least one controlled release product performance analysis result comprises a time of re-application of a controlled release product and optionally at least one of an amount of at least one active released at a plurality of pre-selected time intervals from a controlled release product; a release rate of at least one active from said controlled release product over time; a suggested application rate of a controlled release product, or a controlled release product analysis of at least one active from a controlled release product.

50. A method of performing a computerized on-line controlled release product performance analysis for a controlled release product including at least one active comprising:
(a) inputting a plurality of parameter requirements in a request on a client computer;
(b) sending said request from said client computer to a provider computer;
(c) receiving said request by said provider computer for a controlled release product performance analysis;
(d) analyzing said plurality of parameter requirements in said request, wherein said provider computer uses a routine to analyze said plurality of parameter requirements;
(e) calculating at least one controlled release product performance analysis result based upon said analyzing of said plurality of parameter requirements from said request; and
(f) receiving said at least one controlled release product performance analysis result by said client computer, wherein said at least one controlled release product performance analysis result comprises a time of re-application of a controlled release product and optionally at least one of an amount of at least one active released at a plurality of pre-selected time intervals from a controlled release product; a release rate of at least one active from said controlled release product over time; a suggested application rate of a controlled release product, or a controlled release product analysis of at least one active from a controlled release product.

51. The method of claim 49 or 50, wherein said routine comprises:
reviewing said plurality of parameter requirements inputted in said request;
comparing said plurality of parameter requirements inputted in said request to actual active or actives release data stored in a storage medium; and
calculating and accumulating active or actives release for a series of time intervals based upon said plurality of parameter requirements inputted in said request.

52. The method according to claim 49 or 50, wherein said at least one controlled release product performance analysis result provides said release rate in pounds active or actives per 1000 square feet or kilograms active or actives per 100 square meters.

53. The method according to claim 49 or 50, wherein said at least one controlled release product performance analysis result provides said suggested application rate of said controlled release product in pounds per 1000 square feet or kilograms per 100 square meters.

54. The method according to claim 49 or 50, wherein said plurality of parameter requirements include at least one of facility type, calculation units, country, state, city, name of facility, acres or area to treat, controlled release product analysis percent, particle size, percent active or actives, product list, application date, application rate, temperature correction or any combination thereof.

55. The method according to claim 54, wherein said calculation units include at least one of English or metric units.

56. The method according to claim 49 or 50, wherein said at least one controlled release product performance analysis result further comprises an indicator of when active or actives release falls below a level required to maintain optimum conditions in a controlled release product treated environment.

57. The method according to claim 49, said method further comprising:
repeating (a) through (d) to receive a new at least one controlled release product performance analysis result based upon a new plurality of parameter requirements inputted in a request on said client computer.

58. The method according to claim 50, said method further comprising:
repeating (a) through (f) to receive a new at least one controlled release product performance analysis result based upon a new plurality of parameter requirements inputted in a request on said client computer.
